(19) United States
(12) Patent Application Publication
(10) Pub. No.: US 2019/0226492 A1
(43) Pub. Date: Jul. 25, 2019

(54) SERRATED FAN BLADE, AXIAL FAN, AND CENTRIFUGAL FAN

(71) Applicants: Nidec Corporation, Kyoto (JP); Nidec Singapore PTE., Ltd., Singapore (SG)

(72) Inventors: Chidambaresan KRISHNASWAMI, Singapore (SG); Vishnu HARIPRASAD, Singapore (SG); Sethuraman BOOPATHY, Singapore (SG); Yoshihiro ITAZU, Kyoto (JP)

(21) Appl. No.: 16/313,927

(22) PCT Filed: Jun. 20, 2017
(86) PCT No.: PCT/JP2017/022697

§ 371 Date: Dec. 28, 2018

(30) Foreign Application Priority Data
Jul. 5, 2016 (JP) 2016-133177

(51) Int. Cl. F04D 29/38; F04D 29/66; F04D 29/28

(52) U.S. Cl. CPC F04D 29/384; F04D 29/666; F04D 29/281; F05B 2250/182; F05B 2240/301; F05B 2250/73; F05B 2260/96

(57) ABSTRACT

A trailing edge of a serrated fan blade includes a notch array including first, second, and third notches in a row. The first notch and the second notch define a first serration therebetween, and the second notch and the third notch define a second serration therebetween. The second notch has a largest or a smallest depth among depths of the first to third notches, and the first and second serrations each have an asymmetrical shape.

### BACKGROUND OF THE INVENTION

### 1. Field of the Invention

The present disclosure relates a serrated fan blade, an axial fan, and a centrifugal fan.

### 2. Description of the Related Art

An axial fan is a blowing device that distributes air or other gases in an axial direction with a plurality of blades rotating about an axis. Each blade includes an airfoil structure (an airfoil) including a leading edge and a trailing edge. A centrifugal fan is a blowing device that distributes air or other gases towards the outside in a radial direction with a plurality of blades rotating about a shaft.

Many of conventional blades are provided with a plurality of serrated protrusions (serrations) in a leading edge or a trailing edge of a blade to reduce noise.

The mechanism in which noise near a trailing edge of a blade is generated is one of the main issues in aeroacoustics. Reduction of noise is not yet sufficient in a conventional blade having a serrated shape in the trailing edge. Further reduction of aerodynamic noise without decreasing the fan characteristics is required.

### SUMMARY OF THE INVENTION

A serrated fan blade according to an exemplary embodiment of the present disclosure provides an airfoil structure including a leading edge and a trailing edge, in which each of the leading edge and the trailing edge extend between an inner base and an outer distal end. The trailing edge includes a plurality of notches including a first notch, a second notch, and a third notch adjacent to each other in a row. The first notch and the second notch define a first serration between the first notch and the second notch. The second notch and the third notch define a second serration between the second notch and the third notch. The second notch has a largest or a smallest depth among the depths of the first to third notches, and the first and second serrations each have an asymmetrical shape.

A serrated fan blade according to another exemplary embodiment of the present disclosure provides an airfoil structure including a leading edge and a trailing edge, in which each of the leading edge and the trailing edge extend between an inner base and an outer distal end. The trailing edge includes a plurality of notches including a first notch, a second notch, a third notch, and a fourth notch adjacent to each other in a row. The first notch and the second notch define a first serration between the first notch and the second notch. The second notch and the third notch define a second serration between the second notch and the third notch. The third notch and the fourth notch define a third serration between the third notch and the fourth notch. The second and the third notches each have a depth that is smaller than depths of the first to fourth notches.

A centrifugal fan impeller according to a further exemplary embodiment of the present disclosure includes a centrifugal fan including a central axis, an inlet ring, a back plate, a plurality of fan blades arranged between the inlet ring and the back plate about the central axis. The plurality of fan blades each include a leading edge on an inner side in a radial direction, a trailing edge on an outer side in the radial direction, a first end portion connected to the inlet ring, and a second end portion connected to the back plate. At least either of the leading edge and the trailing edge includes a plurality of notches including a first notch, a second notch, and a third notch adjacent to each other in a row. The first notch and the second notch define a first serration between the first notch and the second notch. The second notch and the third notch define a second serration between the second notch and the third notch. The second notch has a depth that is largest or smallest among depths of the first to third notches. The first and the second serrations each have an asymmetrical shape.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a graph illustrating an aerodynamic noise and a spectrum of a frequency thereof in an axial fan in which airfoil structures of blades do not have a serrated shape in a trailing edge thereof.

FIG. 2A is a drawing illustrating a basic example configuration of a fan blade according to an exemplary embodiment of the present disclosure.

FIG. 2B is a cross-sectional view taken along line IIB-IIB in FIG. 2A.

FIG. 3 is a drawing illustrating an example configuration of a notch array provided in a fan blade according to an exemplary embodiment of the present disclosure.

FIG. 4 is a drawing illustrating parameters defining a dimension of each notch.

FIG. 5 is a drawing illustrating parameters defining a size of each serration.

FIG. 6 is a drawing schematically illustrating a manner in which an airflow on a surface of a fan blade according to an exemplary embodiment of the present disclosure receives the funneling effect by the asymmetrical serration.

FIG. 7 is a drawing illustrating another example configuration of the notch array provided in a fan blade according to an exemplary embodiment of the present disclosure.

FIG. 8 is a drawing illustrating further another example configuration of the notch array provided in a fan blade according to an exemplary embodiment of the present disclosure.

FIG. 9 is a drawing illustrating further another example configuration of the notch array provided in a fan blade according to an exemplary embodiment of the present disclosure.

FIG. 10 is a drawing illustrating further another example configuration of the notch array provided in a fan blade according to an exemplary embodiment of the present disclosure.

FIG. 11 is a drawing illustrating parameters defining an asymmetry of a notch.

FIG. 12 is a drawing illustrating further another example configuration of the notch array provided in a fan blade according to an exemplary embodiment of the present disclosure.

FIG. 13 is a perspective view illustrating an axial fan 1000 according to an exemplary embodiment of the present disclosure.

FIG. 14 is a drawing illustrating the front (left) and the side (right) of the axial fan 1000 according to an exemplary embodiment of the present disclosure.

FIG. 15 is a side view illustrating an axial fan 1000 according to an exemplary embodiment of the present disclosure.

FIG. 16 is a drawing schematically illustrating a relationship between a motion of the fan blades in the axial fan 1000 according to an exemplary embodiment of the present disclosure and the airflow.

FIG. 17 is a front view of the axial fan 1000 according to an exemplary embodiment of the present disclosure including a housing 60.

FIG. 18 is a longitudinal section of the axial fan 1000 according to an exemplary embodiment of the present disclosure.

FIG. 19 is a drawing illustrating the front (left) and the side (right) of the axial fan 1000 according to an exemplary embodiment of the present disclosure, which has been modified.

FIG. 20 is a drawing illustrating, in an enlarged manner, a region surrounded by a circle A in FIG. 19.

FIG. 21 is a drawing illustrating another configuration of a fan blade according to an exemplary embodiment of the present disclosure.

FIG. 22 is a graph illustrating a noise characteristic obtained from an example of the axial fan 1000 illustrated in FIG. 13 and that from a comparative example.

FIG. 23 is a graph illustrating a noise characteristic obtained from an example of the axial fan 1000 illustrated in FIG. 21 and that from a comparative example.

FIG. 24 is a drawing illustrating a centrifugal fan impeller according to an exemplary embodiment of the present disclosure.

FIG. 25 is a front view schematically illustrating a shape of a fan blade 240.

FIG. 26 is a drawing illustrating another centrifugal fan impeller according to an exemplary embodiment of the present disclosure.

### DETAILED DESCRIPTION OF THE PREFERRED EMBODIMENTS

Aerodynamic noise is formed by a complex combination of a monopole sound source, a dipole sound source, and a quadrupolar sound source. In an apparatus including a plurality of rotating fan blades (hereinafter, may be referred merely as “blades”), the dipole sound source generated near a surface of each blade is the dominant noise source. In such an apparatus, it can be conceived that the quadrupolar sound source caused by a turbulent flow or a vortex contributes to generation of the noise as well. The aerodynamic noise generated from these sound sources contains a component distributed in a wide frequency band and a component that shows a high peek at a specific frequency. Noise that shows a high peek at a specific frequency is called a blade pass tone (BPT) and is unpleasant to the ears. The lowest frequency (a first BPF) at which the blade pass tone is generated is determined by the number of blades and the rotating speed (rotation speed). Specifically, when X is the number of blades, and Y is the rotating speed (the number of rotation per minute), the first BPF is expressed by the following equation.

First BPF=X×(Y/60) [unit: Hz]

The blade pass tone contains a component (a fundamental wave component) generated in the first BPF, and a harmonic component thereof. In the present specification, the component generated in the first BPF is referred to as a first blade pass tone (a first BPT).

When the number of blades X is 5 and the rotating speed Y is 20,000 rotations per minute, the first BPF=5×20000/60≈1667 (Hz) is obtained with the equation described above. In such a case, overall, the blade pass tone has a frequency that is a multiplication of about 1667 Hz by a natural number (a positive integer). A sound pressure level of the first BPT is the highest in the entire blade pass tone and shows a noise peak. A sound pressure level of the harmonic component tends to become lower as the frequency becomes higher. If the sound pressure level of the first BPT can be reduced, the overall blade pass tone can be reduced and the noise of the fan can be reduced.

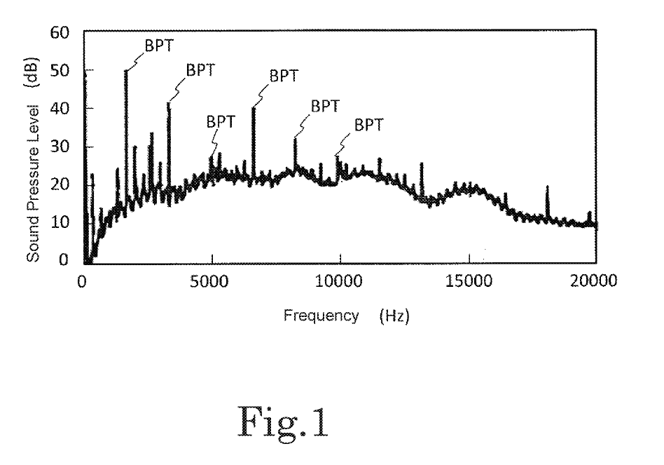

FIG. 1 is a graph illustrating an example of a noise spectrum of an axial fan that does not have blades with serrated trailing edges. An axis of abscissas of the graph represents a frequency (unit: Hz) of the noise, and an axis of ordinates represents a sound pressure level (unit: dB) of the noise. As illustrated in FIG. 1, the blade pass tones are observed in some of the frequencies. The above frequencies are each a multiplication of the first BPT by a positive integer.

According to embodiments of the fan blades and the axial fan of the present disclosure, blade trailing edges each having a special serrated shape act on the generation and disappearance process of the turbulent flows and vortexes, and noise caused by both dipole and quadrupolar sound sources can be decreased.

An example basic configuration and an effect of the fan blades of the present disclosure will be described before describing the embodiments of the present disclosure in detail.

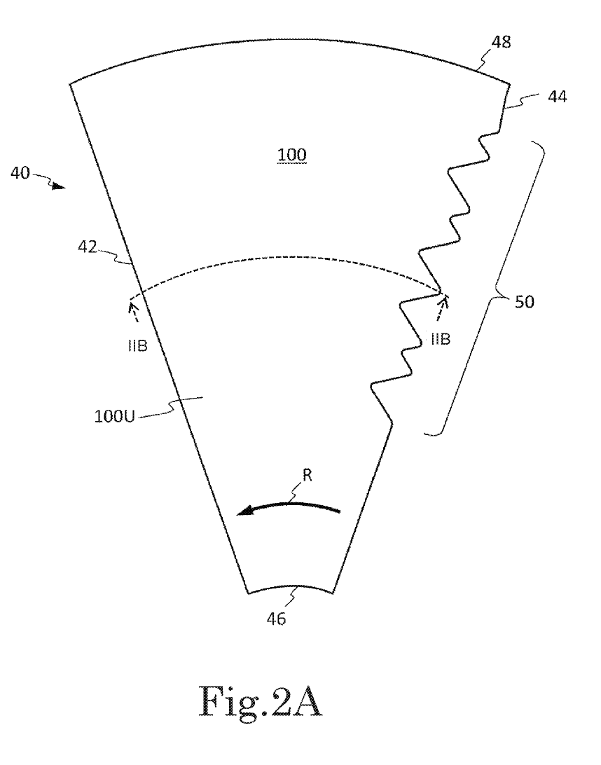

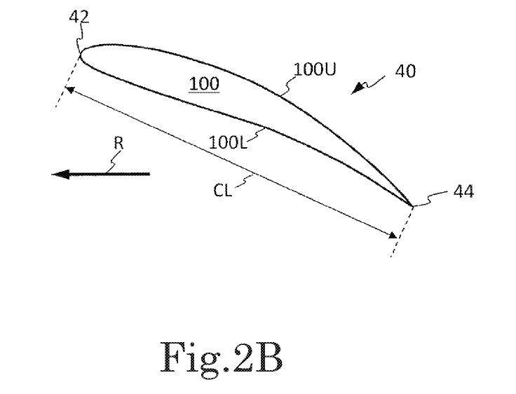

Referring first to FIGS. 2A and 2B, an example of a basic configuration of a fan blade of the present disclosure will be described. A fan blade 40 exemplified in FIG. 2A has an airfoil structure 100 including a leading edge 42 and a trailing edge 44. The leading edge 42 and the trailing edge 44 each extend between an inner base 46 connected to a hub (not shown), and an outer distal end 48. In the present specification, the hub and the plurality of fan blades 40 that extend outwardly in a radial direction are collectively referred to as an impeller. Furthermore, a centrifugal fan described later may include, as the impeller, a structure that includes an inlet ring, a back plate, and the plurality of fan blades and that rotates about a central axis Rx. The impeller may be a single and monolithic synthetic resin component formed by casting or may be a metal workpiece. The impeller may be an assembly of a plurality of components formed of different materials. Note that the impeller is called an impeller in some cases.

The fan blades 40 rotate in a direction depicted by an arrow R in FIG. 2A. Relative to the rotating fan blade 40, gas such as air flows from the leading edge 42 towards the trailing edge 44. The trailing edge 44 of the airfoil structure 100 includes a notch array 50 that forms a serrated shape. A structure of the notch array 50 serves an important role in reducing the aerodynamic noise, as will be described later.

FIG. 2B is an example of a cross section of the airfoil structure 100 taken along a broken line IIB-IIB in FIG. 2A. The airfoil structure 100 includes a pressure reducing surface 100U and a pressure applying surface 100L that connect the leading edge 42 and the trailing edge 44 to each other. When the fan blade 40 is rotating in the direction depicted by the arrow R, airflows flow along the pressure reducing surface 100U and the pressure applying surface 100L from the leading edge 42 towards the trailing edge 44. A length CL from the leading edge 42 to the trailing edge 44 is referred to as a chord length (a chord). The airfoil structure 100 illustrated in the drawing has a camber structure in which the pressure reducing surface 100U is curved convexly; however, the embodiment of the fan blade of the present disclosure does not have to have a camber structure. The thickness of the airfoil structure 100 may be substantially uniform.

In the example illustrated in FIG. 2A, the leading edge extends in a linear manner in the radial direction of the rotation and, except for the serrated portion, the trailing edge 44 practically extends in a linear manner as well along the radial direction of the rotation. Accordingly, the chord length CL of the fan blade 40 exemplified in FIG. 2A has a different value depending on the position in the radial direction. The brief configuration of the fan blade 40 is not limited to the above example and may have a sweptback-wing profile or a sweptforward-wing profile. In other words, the leading edge 42 and the trailing edge 44 do not have to extend in a linear manner in the radial direction and, overall, may be inclined or curved.

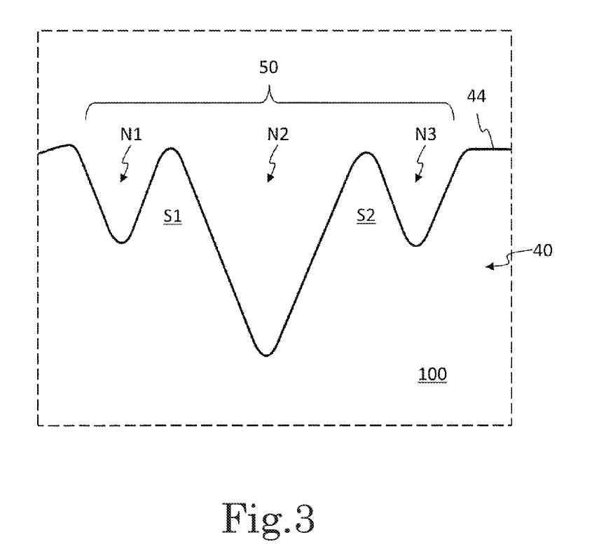

Referring next to FIG. 3, a configuration of the notch array 50 will be described. The notch array 50 at least incudes a first notch N1, a second notch N2, and a third notch N3 aligned adjacent to each other in a row. The notch array 50 may include other notches. Each of the notches N1, N2, and N3 illustrated in the drawing is a recessed portion having a substantially V-shape; however, the shape of each of the notches is not limited to the above example. The adoptable diverse shapes of the notches will be described later.

The first notch N1 and the second notch N2 adjacent to each other forms a first serration S1 between the first notch N1 and the second notch N2. Similarly, the second notch N2 and the third notch N3 adjacent to each other form a second serration S2 between the second notch N2 and the third notch N3. Each serration illustrated in the drawing is a protrusion having a substantially inverted V-shape and can be called as a “tooth”. The shape of each serration is not limited to the above example. The adoptable diverse shapes of the serrations will be described later.

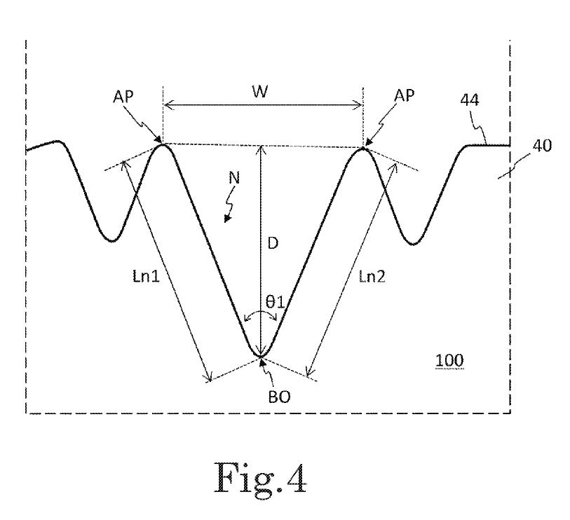

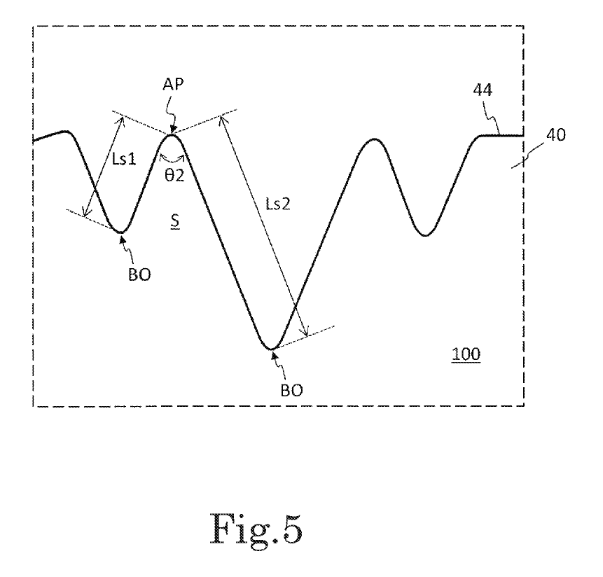

Referring to FIGS. 4 and 5, parameters defining the dimensions of the notches and the serrations will be described.

FIG. 4 is a drawing illustrating the parameters defining a dimension of a notch. FIG. 4 denotes parameters defining a shape of a single notch N. The above parameters are similar in the other notches as well. As depicted in FIG. 4, the notch N has a width W and a depth D. The width W is a distance of a line segment connecting two adjacent apex portions AP (apex portions of the serration) in the serrated trailing edge 44. The depth D is a distance from a midpoint M of the above line segment to an opposing bottom portion (a bottom portion of the serrated trailing edge 44) BO of the notch N. In the example depicted in FIG. 4, the apex portions AP and the bottom portion BO are rounded. An effect of suppressing noise (an edge tone), which tends to occur when there is an abrupt change in the direction of the airflow, from occurring can be obtained with such roundnesses. Furthermore, in order to obtain such an effect, the radius of curvature of each roundness may be in the range of 0.3 mm to 0.5 mm, for example. Furthermore, the roundnesses may be provided in either of the apex portions AP or the bottom portions BO.

A line that connects one of the two apex portions AP that define the notch N and the bottom portion BO is referred to as a first side Ln1 of the notch, and a line that connects the other one of the two apex portions AP and the bottom portion BO is referred to as a second side Ln2 of the notch. For simplicity, lengths of first side Ln1 and the second side Ln2 are depicted as Ln1 and Ln2, respectively. An angle of the bottom portion formed between the first side Ln1 and the second side Ln2 is denoted as θ1.

In the example in FIG. 4, most of both the first side Ln1 and the second side Ln2 are straight lines and have about the same length. In the above example, the Ln1 and the Ln2 in each of the notches illustrated in the drawing are about the same. However, when the sizes of two adjacent notches are compared, the width W, the depth D, and the lengths Ln1 and Ln2 of one notch are different from the width W, the depth D, and the lengths Ln1 and Ln2 of the other notch. In the example in FIG. 4, the bottom portion angle θ1 of each notch is about the same.

In a representative example of the serrated fan blade 40 of the present disclosure, as illustrated in FIG. 4, a notch that has a relatively large depth D and a notch that has a relatively small depth D are arranged alternately. Furthermore, in the embodiment of the present disclosure, the depths of the first notch N1, the second notch N2, and the third notch N3 are each 5% or more to 35% or less of the chord length CL, for example. Furthermore, the widths of the first notch N1 and the third notch N3 are each 0.5 times or more to 3 times or less of the depths of the first notch N1 and the third notch, respectively, and the width of the second notch N2 is 0.5 times or more to 3 times or less of the depth of the second notch N2. Each bottom portion angle θ1 is almost determined by the depth D and the width W of the corresponding notch. The bottom portion angle θ1 is in the range of 15 degrees or more to 75 degrees or less, for example.

Note that when used in an axial fan, the chord length CL of the serrated fan blade according to the present disclosure is, in a representative example thereof, in the range of 20 mm or more to 50 mm or less, for example. When the serrated fan blade according to the present disclosure is used in an apparatus other than an axial fan, the chord length CL can be of any size according to the size of the apparatus.

FIG. 5 is a drawing illustrating parameters defining a size of a serration S. FIG. 5 denotes parameters defining a shape of a single serration S. The above parameters are similar in the other serrations as well. As illustrated in FIG. 5, the serration S is defined by a first side Ls1 and a second side Ls2 that are portions of the trailing edge 44 of the blade 40. For simplicity, lengths of the first side Ls1 and the second side Ls2 are depicted as Ls1 and Ls2, respectively. An angle of an apex portion formed between the first side Ls1 and the second side Ls2 is denoted as θ2. A portion of the trailing edge 44 of the blade 40 serves both as the side of the serration S and the side of the notch N. For example, the second side Ls2 of the serration S illustrated in FIG. 5 is also the first side Ln1 of the notch N illustrated in FIG. 4. Note that the apex portions angle θ2 is in the range of 15 degrees or more to 75 degrees or less, for example.

In the example in FIG. 5, the first side Ls1 and the second side Ls2 are mostly straight lines, and have lengths that are different from each other. In the present disclosure, the serration S in which the length of the first side Ls1 and the length of the second side Ls2 are different will be referred to as a serration having an asymmetrical shape. Between the lengths Ls1 and Ls2, the ratio of the long length to the short length is, typically, in the range of 1.2 or more to 10 or less.

FIG. 3 is referred to again. In the fan blade 40 illustrated in FIG. 3, the second notch N2 has the largest depth among the depths of the first to third notches N1, N2, and N3. The first and second serrations S1 and S2 formed by adjacent notches having different depths each have an asymmetrical shape in which the length of the left and right sides are different from each other. In order for the first and second serrations S1 and S2 to have effective asymmetrical shapes, the depths of the first notch N1 and the third notch N3 can be set in the range of 33% or more to 83% or less of the depth of the second notch N2.

When the notch array 50 is provided in the trailing edge 44 of the fan blade 40, vortexes that rotate in opposite directions with respect to each other are formed near the base of the serrations and extend in the direction of the flow. Such vortexes create a funneling effect and change the characteristics of the turbulent flow as the vortexes approach the sides (the trailing edge 44) of the serrations.

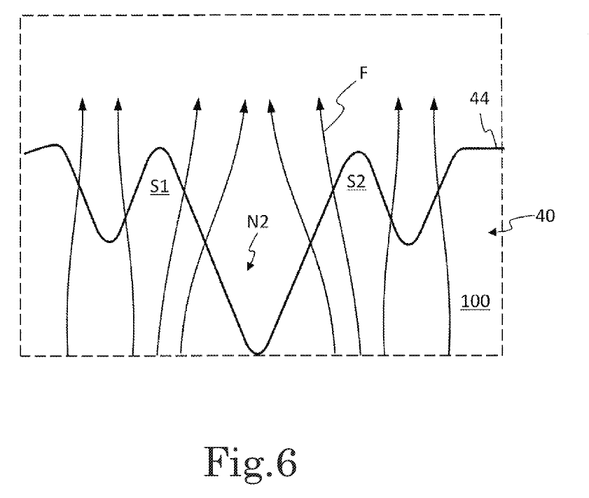

FIG. 6 is a drawing schematically illustrating the manner in which the airflow on the surface of the fan blade 40 receives the funneling effect exerted by the asymmetrical serration. According to an investigation of the inventors and the like, it has been understood that when serrations that have asymmetrical shapes S1 and S2 that have different left and right lengths are disposed adjacent to each other as illustrated in FIG. 6, a difference in intensity is created in the adjacent vortexes and the vortexes interfering with each other become promptly attenuated. Such interferences between the vortexes were not clearly observed in a case in which each of the serrations had a symmetrical shape; accordingly, it is considered that the effect is due to the asymmetrical shapes of the serrations.

Serrations having asymmetrical shapes create an asymmetrical funneling effect. Vortexes (counter-rotating streetwise oriented vortices) in opposite directions having different intensities are created and interfere with each other with a configuration (a staggered arrangement) in which two types of serrations in which the dimensional relationships between the lengths of the left and right sides are opposite each other are arranged alternately. Such interferences quicken the disappearance of the vortexes, and contribute to noise reduction. Typically, the noise reduction effect is exerted in a configuration in which two types of serrations each having an asymmetrical shape are adjacent to each other. As described later, even when another serration (which does not have to have an asymmetrical shape) is inserted between the two types of serrations, a similar effect can be obtained.

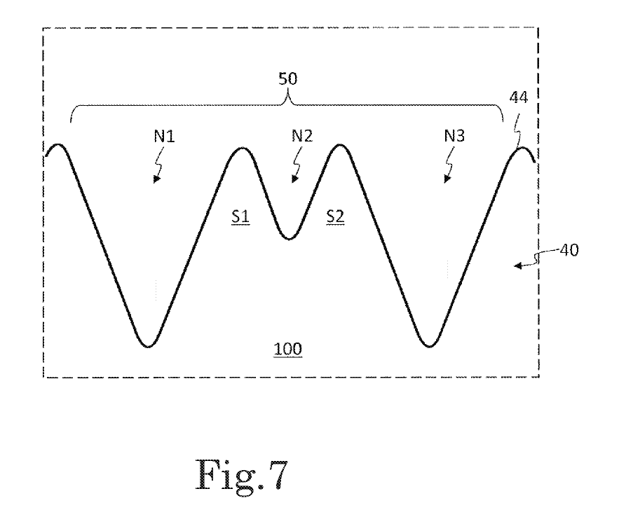

In the fan blade of the present disclosure, the asymmetrical serrations are formed by arranging the notches having different sizes, and with that, the layers of vortexes can be appropriately controlled and noise can be reduced. However, it is not essential that the second notch N2 has the largest depth among the depths of the first to third notches N1, N2, and N3 in order to obtain such an effect. As illustrated in FIG. 7, the second notch N2 may have the smallest depth among the depths of the first to third notches N1, N2, and N3.

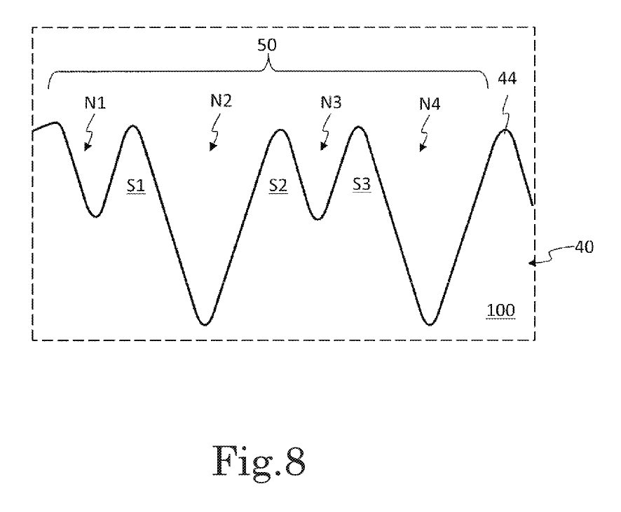

FIG. 8 is a drawing illustrating further another example configuration of the notch array provided in the fan blade 40 of the present disclosure. In the example illustrated in FIG. 8, the notch array 50 of the fan blade 40 illustrated in FIG. 3 includes a fourth notch N4 adjacent to the third notch N3. The third notch N3 and the fourth notch N4 form a third serration S3 between the third notch N3 and the fourth notch N4. The fourth notch N4 has a depth that is larger than that of the third notch N3.

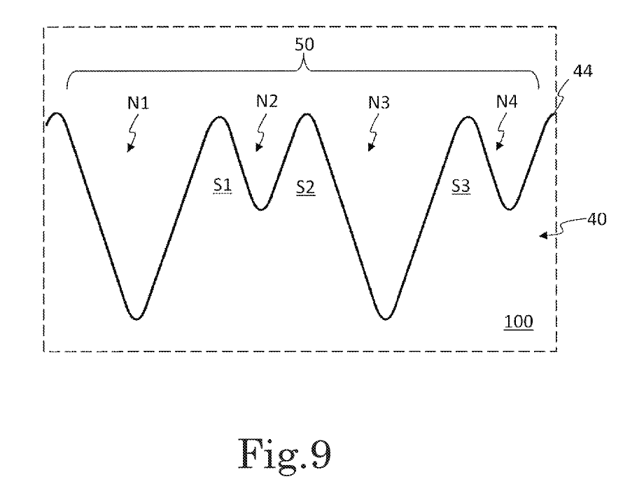

FIG. 9 is a drawing illustrating further another example configuration of the notch array provided in the fan blade 40 of the present disclosure. In the example illustrated in FIG. 9, the notch array 50 of the fan blade illustrated in FIG. 7 includes a fourth notch N4 adjacent to the third notch N3. The third notch N3 and the fourth notch N4 form a third serration S3 between the third notch N3 and the fourth notch N4. The fourth notch N4 has a depth that is smaller than that of the third notch N3.

As described above, representative examples of the staggered arrangement described above can be provided by having two types of notches that have different depths with respect to each other be alternately aligned.

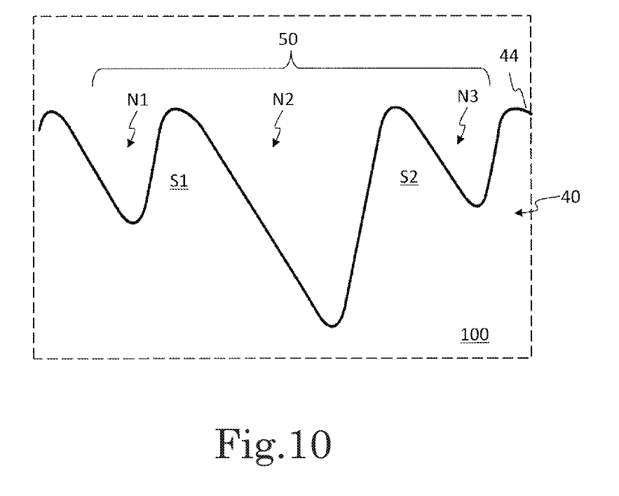

FIG. 10 is a drawing illustrating further another example configuration of the notch array provided in the fan blade 40 of the present disclosure. In the example illustrated in FIG. 10, each of the first to third notches N1, N2, and N3 has an asymmetrical shape. An asymmetrical shape of the notch is a shape illustrated in FIG. 4 in which the length of the first side Ln1 and the length of the second side Ln2 are different from each other. In the notch array 50 exemplified in FIG. 10 as well, the second notch N2 has the largest depth among the depths of the first to third notches N1, N2, and N3. Note that as illustrated in FIG. 7, the second notch N2 may have the smallest depth among the depths of the first to third notches N1, N2, and N3. In such a case, each of the first to third notches N1, N2, and N3 in the fan blade 40 illustrated in FIG. 7 may have an asymmetrical shape.

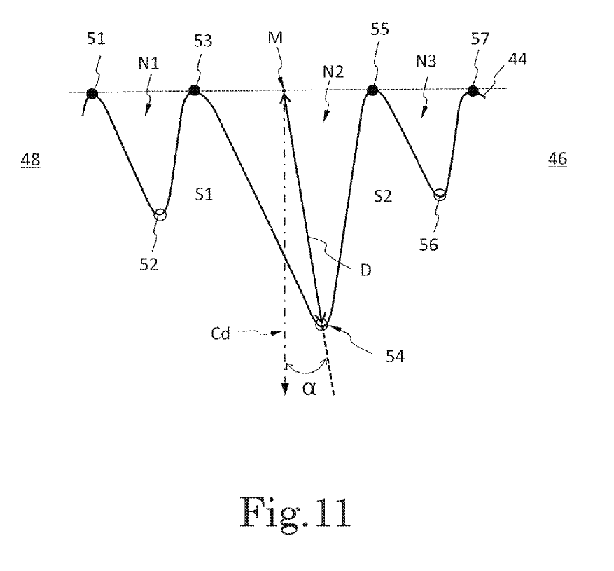

FIG. 11 is a drawing illustrating parameters defining an asymmetric shape of a notch. The serrated trailing edge 44 illustrated in FIG. 11 includes four apex portions 51, 53, 55, and 57 and three bottom portions 52, 54, and 56. Herein, a focus will be given on the second notch N2. A distance of a line segment D connecting a midpoint M of a line segment connecting the two adjacent apex portions 53 and 55 and a bottom portion 54 opposing the notch N2 corresponds to a depth D of the second notch N2. The line segment D is inclined with respect to a direction Cd of the chord length, and forms an angle (an inclination angle) α that is not zero degrees. The inclination angle α has a positive value when the line segment D is inclined towards the inner base 46 side of the blade 40, and has a negative value when inclined towards the outer distal end 48 side. In the example illustrated in FIG. 11, the inclination angle α of the second notch N2 has a positive value. When the inclination angle α has a positive value, the first side Ln1 is closer to the outer distal end 48 than the second side Ln2. Furthermore, the first side Ln1 is longer than the second side Ln2.

Such an inclination angle α can be set in the range of minus 60 degrees or larger to plus 60 degrees or smaller, for example. In a case in which the line segment D is inclined towards the inner base 46 side, when the inclination angle α of each of the notches has a positive value, an effect in that the formation of vortexes is facilitated along the locus of the blade surface can be obtained.

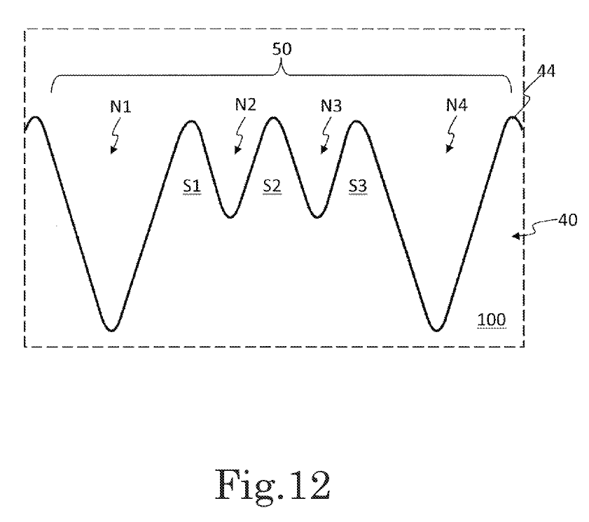

FIG. 12 is a drawing illustrating further another example configuration of the notch array provided in the fan blade 40 of the present disclosure. In the example illustrated in FIG. 12, an array 50 having a plurality of notches include a first notch N1, a second notch N2, a third notch N3, and a fourth notch N4. The first notch N1 and the second notch N2 form a first serration S1 between the first notch N1 and the second notch N2. The second notch N2 and the third notch N3 form a second serration S2 between the second notch N2 and the third notch N3. The third notch N3 and the fourth notch N4 form a third serration S3 between the third notch N3 and the fourth notch N4.

A feature of the notch array 50 illustrated in FIG. 12 is that the depth of each of the second and third notches N2 and N3 is smaller than those of the first and fourth notches N1 and N4. In such an example configuration, the second serration S2 is situated at a position interposed between the first and third serrations S1 and S3 that each have an asymmetrical shape. The second serration S2 in the example has a symmetrical shape in which the lengths of the left and right sides are the same. An effect that is almost similar to the effect described with reference to FIG. 6 can be obtained in such a configuration as well.

In the above-described example illustrated in the drawing, each notch has sides that extend in a linear manner and a round bottom and overall has a V-shape or a triangular shape; however, the shapes of the notches of the present disclosure are not limited to such an example. The sides of each notch do not have to include linear portions. Furthermore, each notch may include a minute unevenness.

Hereinafter, an embodiment of the present disclosure will be described in detail. However, descriptions that are more than necessary may be omitted. For example, detailed descriptions of matters that are already known and redundant descriptions of practically the same components may be omitted. The above is for avoiding the following description from becoming unnecessarily redundant and for facilitating the understanding of the persons skilled in the art. The inventors and the like will provide the attached drawings and the following description so that the persons skilled in the art will understand the present disclosure in a sufficient manner. The above is not intended to limit the subject matter described in the scope of claims.

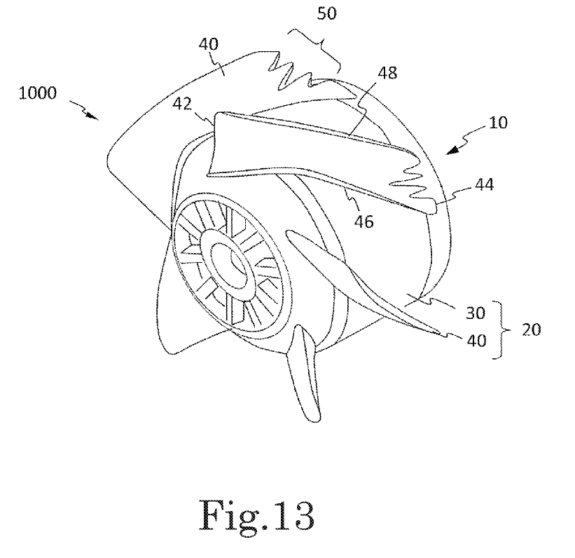

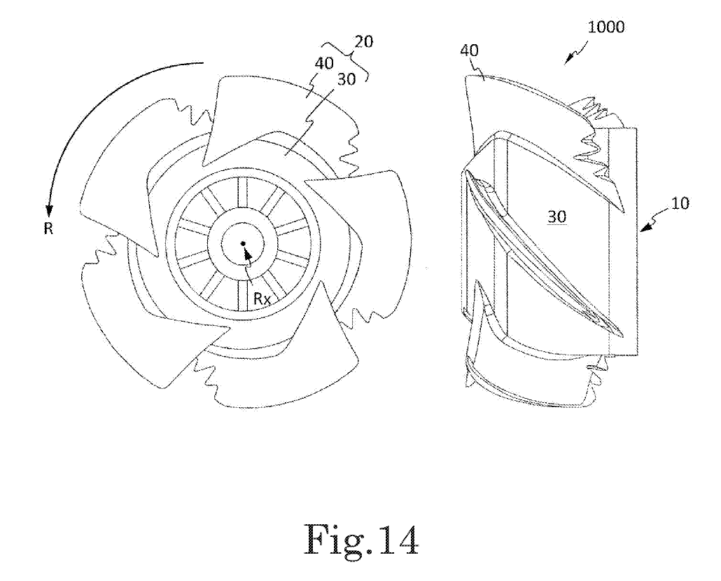

Referring first to FIGS. 13 and 14, an example basic configuration of an axial fan 1000 according to an embodiment of the present disclosure will be described. FIG. 13 is a perspective view illustrating the axial fan 1000 according to the above embodiment. FIG. 14 is a drawing illustrating the front (left) and the side (right) of the axial fan 1000 according to the present embodiment.

The axial fan 1000 according to the present embodiment includes a motor 10, and an impeller 20 connected to the motor 10. The impeller 20 includes a hub 30, and a plurality of fan blades 40 connected to the hub 30. In the example illustrated in the drawing, the number of fan blades 40 is five and each of the fan blades 40 has the configuration illustrated in FIG. 3. In other words, each fan blade 40 includes the airfoil structure 100 having the leading edge 42 and the trailing edge 44, and the leading edge 42 and the trailing edge 44 each extend between the inner base 46 and the outer distal end 48. The trailing edge 44 includes the notch array 50 having the configuration described above.

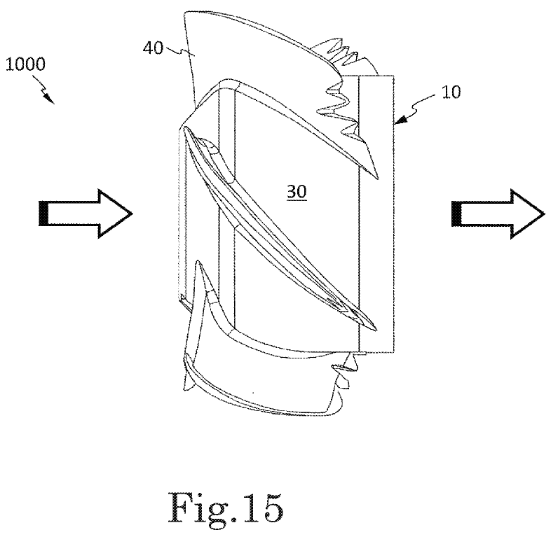

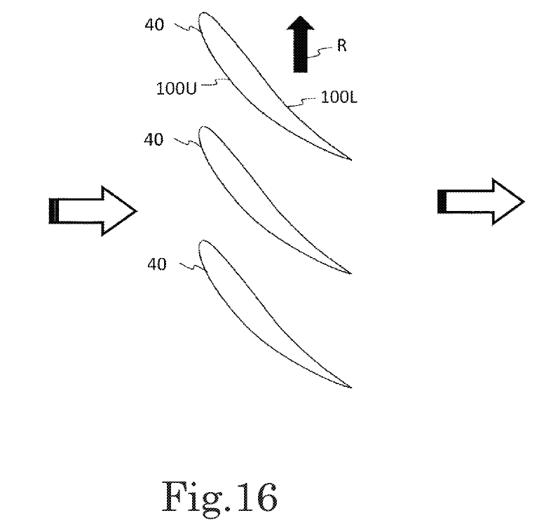

FIGS. 15 and 16 will be referred to next. FIG. 15 is a side view of the axial fan 1000 according to the present embodiment. FIG. 16 is a drawing schematically illustrating a relationship between a motion of the fan blades 40 in the axial fan 1000 in FIG. 15 and the airflow. With the rotation of the motor 10, the hub 30 rotates together with a rotor described later. In so doing, the blades 40 move in the direction of the arrow R, as schematically illustrated in FIG. 16. With such a motion of the blades 40, an overall airflow (an axial flow) is generated in a direction depicted by hollow arrows in FIGS. 15 and 16. The left sides of FIGS. 15 and 16 are an “intake side (inlet side)” of the axial fan 1000, and the right sides of the above drawings are an “exhaust side (outlet side)”. As illustrated in FIG. 16, when the blades 40 are viewed from the intake side, the pressure reducing surfaces 100U of the blades 40 are observed.

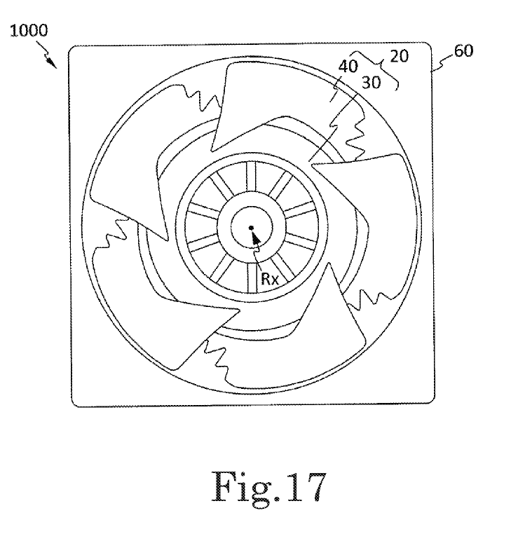

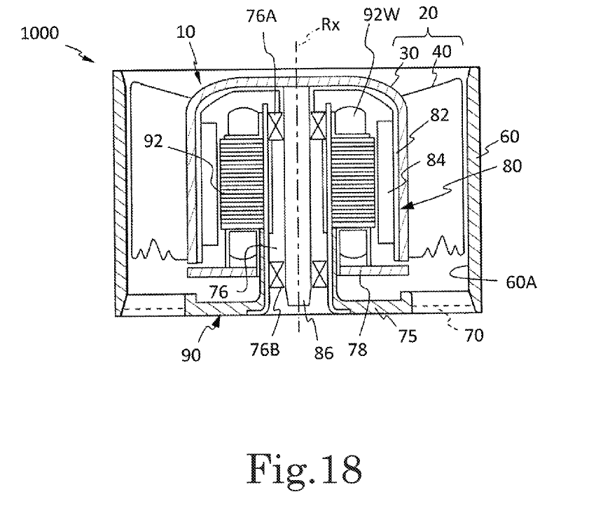

FIG. 17 is a front view of another example of the axial fan 1000 according to the present embodiment. FIG. 18 is a longitudinal section passing through an axis Rx of the axial fan 1000 illustrated in FIG. 17. In the arrangement in FIG. 18, air is drawn into a housing 60 from an upper side in FIG. 18 and is sent out towards a lower side thereof. In other words, a flow of air in a direction of the central axis Rx is generated. Accordingly, in the arrangement in FIG. 18, the upper side of the drawing is the “intake side” and the lower side is the “exhaust side”.

In addition to the components illustrated in FIG. 13, the axial fan 1000 includes the housing 60 that surrounds an outer circumference of the impeller 20, a base 75 on which the motor 10 sits, and a plurality of supporting members (struts) 70 that support the base 75. The plurality of struts 70 extend radially from an outer circumference of the base 75 towards an inner lateral surface 60A of the housing 60, and connect the base 75 and the housing 60 to each other.

In FIG. 18, brief shapes of the blades 40 of the impeller 20 and the struts (broken-line portions) 70 are depicted on the left and right of the central axis Rx. Furthermore, the motor 10 is depicted largely in an exaggerated manner. The shapes and sizes of the components illustrated in the drawing are not limited to the shapes and sizes exemplified in the drawing.

The impeller 20 according to the present embodiment includes the hub 30 that has a cup shape and that covers the outside of the motor 10, and the plurality of blades 40 that project outwards in the radial direction from an outer lateral surface of the hub 30. The plurality of blades 40 are arranged at equidistance in the circumferential direction about the central axis Rx that is also an axis of the rotation center of the motor 10. The hub 30 and the blades 40 of the present embodiment are formed as a single member by injection molding resin.

The motor 10 includes a rotor 80 and a stator 90. In the direction of the central axis Rx, the rotor 80 is positioned on the intake side with respect to the stator 90. The rotor 80 includes a yoke 82 formed of metallic magnetics, a permanent magnet 84 fixed on an inner side of the yoke 82, and a shaft 86 that protrudes downwards from an upper portion and at a center of the yoke 82. The yoke 82 has a cup shape about the central axis Rx. The hub 30 covers the yoke 82, and connects the impeller 20 to the rotor 80.

The stator 90 of the present embodiment includes a substantially disc-shaped base 75, a substantially cylindrical bearing holding portion 76 that protrudes upwards from a center of the base 75, an armature 92 attached to an outer circumference of the bearing holding portion 76, and a substantially annular and tabular circuit board 78 attached below the armature 92.

Various electronic circuit components such as a transistor, a diode, and a capacitor for driving the motor are mounted on the circuit board 78. A memory in which a program for controlling the motor is stored and a microcomputer that operates based on a command of the program may be mounted on the circuit hoard 78. The circuit board 78 is electrically connected to the armature 92 and controls the armature 92.

The armature 92 includes a winding 92W and opposes the permanent magnet 84 in the radial direction. By supplying a driving current to the armature 92 from an external power source and through the circuit board 78, a torque about the central axis Rx is generated between the armature 92 and the permanent magnet 84. Ball bearings 76A and 76B that are bearing mechanisms are provided inside and on the upper portion and the lower portion of the bearing holding portion 76 in the central axis Rx direction. The shaft 86 inserted in the bearing holding portion 76 is rotatably supported by the ball bearings 76A and 76B.

The axial fan 1000 including such components may include stator blades (stator vanes) or guide blades (guide vanes) on at least either the intake side or the exhaust side. Furthermore, a plurality of axial fans 1000 each having a similar configuration may be used while being arranged in parallel or in serial.

The configuration described above is merely an example of the axial fan of the present disclosure, and the embodiments of the present disclosure can adopt other configurations. The number of blades 40 and the structure of the motor 10 may be any number and structure. The motor 10 may be a direct current (DC) motor or may be an alternating current (AC) motor. Furthermore, the shape of the housing 60 is not limited to the example described above and the housing 60 is not essential. The axial fan 1000 may be directly attached to a casing of an electronic device or may be attached to a duct.

A modification of the axial fan 1000 will be described next. Points that are different from the axial fan 1000 illustrated in FIGS. 13 and 14 will be described and the description will not be repeated for similar components.

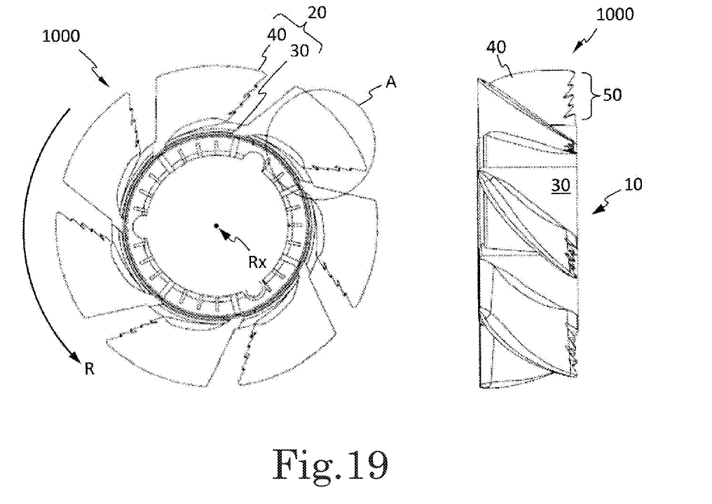

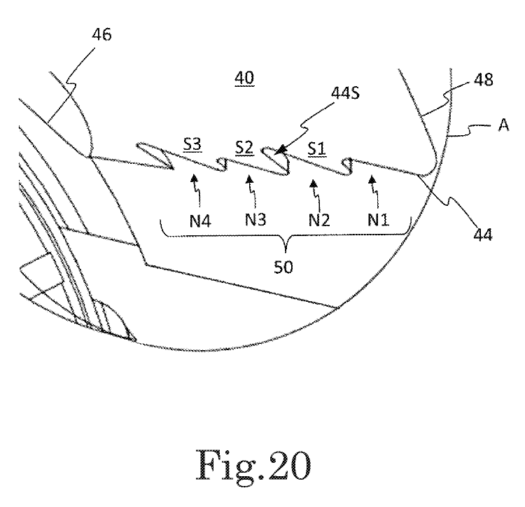

FIG. 19 is a drawing illustrating a front view (left) and a side view (right) of the axial fan 1000 according to the above modification. The axial fan 1000 according to the above modification includes seven fan blades 40. FIG. 20 is an enlarged view of a region of the notch array 50 surrounded by a circle A in FIG. 19, viewed from the intake side (the inlet side). As illustrated in FIG. 20, the trailing edge 44 of the fan blade 40 of the present modification includes the notch array 50 including four notches N1 to N4.

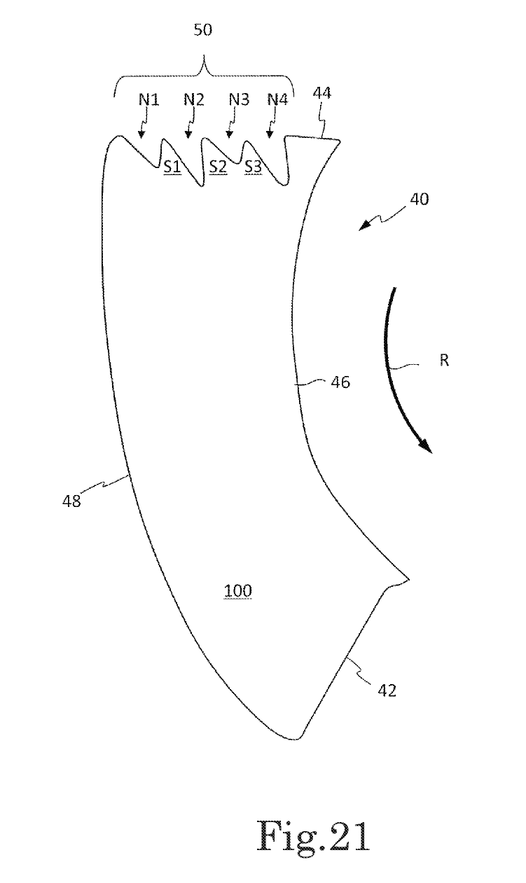

FIG. 21 is a drawing illustrating a configuration of the above fan blade 40. As illustrated in FIG. 21, the above notch array 50 has a configuration that is similar to that illustrated in FIG. 8. In other words, the first to fourth notches N1, N2, N3, and N4 each has an asymmetrical shape. In the above notch array 50, the second notch N2 has the largest depth among the depths of the first to third notches N1, N2, and N3. Furthermore, the fourth notch N4 has a depth that is larger than that of the third notch N3. In other words, the first and third notches N1 and N3 that each have a relatively small depth and the second and fourth notches N2 and N4 that each have a relatively large depth are aligned alternately.

FIG. 20 is referred to again. As illustrated in FIG. 20, portions of a lateral surface 44S of the trailing edge 44 are visible from the intake side. In the lateral surface 44S of the trailing edge 44, the portions that can be observed from the intake side are all positioned on the sides (the second sides) near the inner base 46 among the two sides included in each of the first to fourth notches N1, N2, N3, and N4.

By employing such a configuration, an effect in that processing as mass-produced goods is facilitated can be obtained.

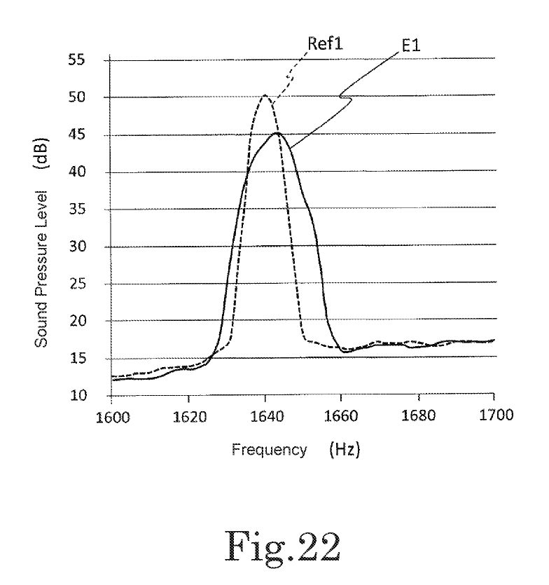

FIG. 22 is a graph illustrating a noise characteristic obtained from an example of the axial fan 1000 illustrated in FIG. 13 and that from a comparative example. An axis of abscissas of the graph shows a frequency (unit: Hz) of the first BPT that is a peak noise, and an axis of ordinates shows a sound pressure level (unit: dB) of the first BPT. A broken line Ref1 shows the first BPT obtained from a first comparative example that had a trailing edge without any serration, and a solid line E1 shows the first BPT obtained from the first example of the axial fan 1000 illustrated in FIG. 13. The sound pressure level of the first BPT of the first example was reduced to about 90% of the sound pressure level of the first BPT of the comparative example.

Furthermore, static pressure-air volume characteristics (P-Q) and the static pressure efficiencies (efficiencies) of the first example and the first comparative example were evaluated. There was almost no difference between the first example and the first comparative example.

Note that in the first example, the first and the third notches N1 and N3 each had a width W of about 1.4 mm and a depth D of about 1.1 mm, and the second notch N2 had a width W of about 1.4 mm and a depth D of about 1.6 mm. The bottom portion angle θ1, the apex portions angle θ2, and the chord length CL were 21.9 degrees, 26.9 degrees, and 23.4 mm, respectively. The rotating speed was 10000 rpm.

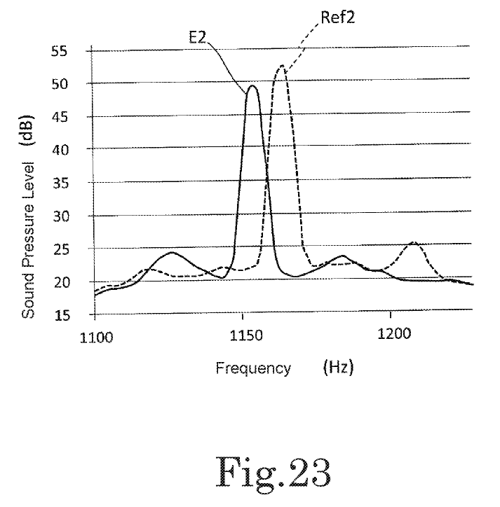

FIG. 23 is a graph illustrating a noise characteristic obtained from an example of the axial fan 1000 according to a modification illustrated in FIG. 19 and that from a comparative example. An axis of abscissas of the graph shows a frequency (unit: Hz) of the first BPT, and an axis of ordinates shows a sound pressure level (unit: dB) of the first BPT. A broken line Ref2 shows the first BPT obtained from a second comparative example that had a trailing edge without any serration, and a solid line E2 shows the first BPT obtained from the second example of the axial fan 1000 illustrated in FIG. 19. The sound pressure level of the first BPT of the above second example was reduced to about 94% of the sound pressure level of the first BPT of the comparative example. The frequency of the first BPT had shifted between the second example and the second comparative example. The shift was caused by a difference (an error) in the rotation speeds.

Furthermore, static pressure-air volume characteristics (P-Q) and the static pressure efficiencies (efficiencies) of the second example and the second comparative example were evaluated. There was almost no difference between the second example and the second comparative example.

Note that in the second example, the first and the third notches N1 and N3 each had a width W of about 1.2 mm and a depth D of about 1.0 mm, and the second and the fourth notches N2 and N4 had a width W of about 1.2 mm and a depth D of about 1.8 mm. The inclination angle α against the direction Cd of the chord length was about +30 degrees in either of the notches N1, N2, N3, and N4. The bottom portion angle θ1, the apex portions angle θ2, and the chord length CL were 21.9 degrees, 26.9 degrees, and 23.4 mm, respectively. The rotating speed was 10000 rpm.

As above, it had been confirmed that the axial fan of the present disclosure is capable of lowering the peak noise by about 5 dB or more without degrading the fan characteristics. Furthermore, by conducting a numerical fluid dynamics simulation using a computer, it was confirmed that the serrated shape included in the blade trailing edge of the present disclosure had an effect on the generation and disappearance process of the turbulent flow and the vortexes and reduced the noise source.

The effect of the serrated shape included in the blade trailing edge of the present disclosure having an effect on the generation and disappearance process of the turbulent flow and the vortexes and reducing the noise source can, as described above, obtained in a similar manner when applied to an apparatus other than an axial fan. A representative example of the apparatus other than the axial fan is a centrifugal fan. Hereinafter, an embodiment of an impeller that is applied to a centrifugal fan of the present disclosure, in other words, an embodiment of a centrifugal fan impeller, will be described.

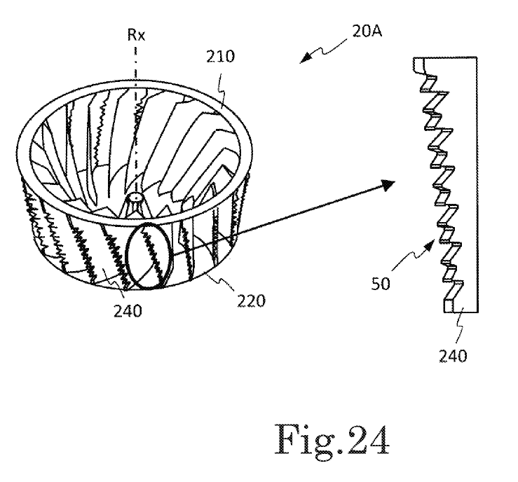

FIG. 24 is a perspective view of a centrifugal fan impeller (hereinafter, merely referred to as an “impeller”) 20A of the present embodiment. The impeller 20A is used while connected to a motor. The impeller 20A includes an inlet ring 210, a back plate 220, and a plurality of fan blades 240 arranged between the inlet ring 210 and the back plate 220 about the central axis Rx.

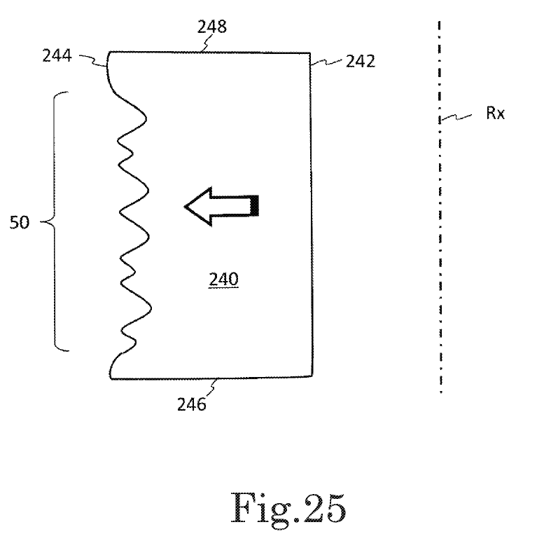

FIG. 25 is a front view schematically illustrating a shape of the fan blade 240. In FIG. 25, the position of the central axis Rx is depicted by a straight line that is a dot and dash line, and a direction of an airflow flowing along the fan blade 240 is depicted by an arrow. As illustrated in FIG. 25, the fan blade 240 includes a leading edge 242 on an inner side in a radial direction, a trailing edge 244 on an outer side in the radial direction, a first end portion 248 connected to the inlet ring 210, and a second end portion 246 connected to the back plate 220. A representative example of the fan blade 240 is a sweptforward-wing or a sweptback-wing, which may extend in the radial direction in a planar manner.

Similar to the blade 40 of the axial fan described above, the trailing edge 244 of the fan blade 240 of the present embodiment includes the notch array 50. The structure and the function of the notch array 50 are as described above, and the detailed description thereof will not be repeated herein.

Sound pressure level of an example of the centrifugal fan provided with the impeller 20A of the present disclosure and that of a comparative example different from the example in that there is no notch array 50 were evaluated. As a result, it was confirmed that the presence of the notch array 50 reduced the sound pressure level by about a few percent.

The inventors and the like have found, as a result of experiments and simulations, that the noise of the centrifugal fan can be reduced when the notch array 50 is provided in the leading edge 242 of each fan blade 240.

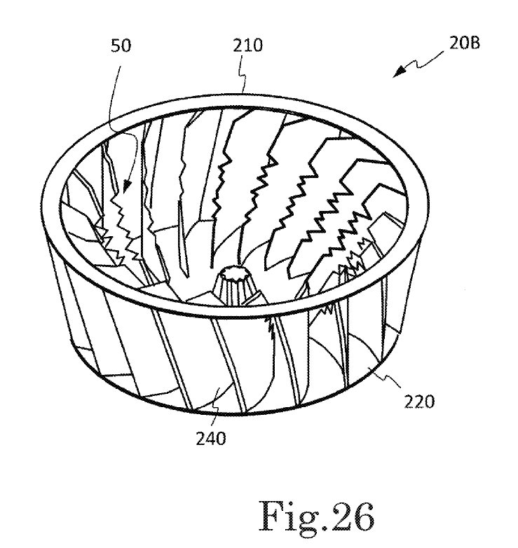

FIG. 26 is a perspective view illustrating an impeller 20B of another embodiment. As illustrated in the drawing, the fan blade 240 of the impeller 20B includes the notch array 50 provided in the leading edge 242. The difference between the above impeller 20B and the impeller 20A described above is the position of the notch array 50.

As described above, in the impeller used in the centrifugal fan of the present disclosure, it is only sufficient that the notch array 50 is provided in at least either one of the leading edge and the trailing edge of the blade. Furthermore, the shape of the notch array 50 is not limited to a single example and, as in the description of the axial fan, can be diverse.

In a typical example, the centrifugal fan of the present disclosure may include a motor and a housing that accommodates the impeller, and can be used while connected to piping such as a duct.

The shapes of the inlet ring 210 and the back plate 220 are not limited to the example illustrated in the drawing. A portion or all of the back plate 220 may form a curved surface. For example, the middle of the back plate 220 may be bulged. An additional structure may be provided in a portion of the inlet ring 210 and/or the back plate 220.

The serrated fan blade of the present disclosure can be widely used in an axial fan and other blowing devices. Furthermore, the axial fan and the centrifugal fan of the present disclosure, for example, can be used in various apparatuses such as a cooling apparatus, a ventilating apparatus, an air conditioner, and an air intake and exhaust device. In particular, the axial fan and the centrifugal fan of the present disclosure can be suitably used for the purpose of cooling a computer server.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-15. (canceled)

16. A serrated fan blade comprising:
an airfoil structure including:
a leading edge and a trailing edge, the leading edge and the trailing edge each extending between an inner base and an outer distal end; wherein
the trailing edge includes a plurality of notches including a first notch, a second notch, and a third notch adjacent to each other in a row;
the first notch and the second notch define a first serration between the first notch and the second notch;
the second notch and the third notch define a second serration between the second notch and the third notch;
the second notch has a depth that is largest or smallest among depths of the first, second and third notches; and
the first and the second serrations each have an asymmetrical shape.

17. The serrated fan blade according to claim 16, wherein the depths of the first, second and third notches are each in a range of 5% to 35%, inclusive, of a chord length of the airfoil structure, and widths of the first, second and third notches are each in a range of 0.5 times to 3 times, inclusive, of the depth of the respective one of the first, second and third notches.

18. The serrated fan blade according to claim 16, wherein the depth of the second notch is largest among the depths of the first, second and third notches.

19. The serrated fan blade according to claim 16, wherein the depth of the second notch is smallest among the depths of the first, second and third notches.

20. The serrated fan blade according to claim 18, wherein
the plurality of notches include a fourth notch adjacent to the third notch;
the third notch and the fourth notch define a third serration between the third notch and the fourth notch; and
the fourth notch has a depth that is larger than that of the third notch.

21. The serrated fan blade according to claim 19, wherein
the plurality of notches include a fourth notch adjacent to the third notch;
the third notch and the fourth notch define a third serration between the third notch and the fourth notch; and
the fourth notch has a depth that is smaller than that of the third notch.

22. The serrated fan blade according to claim 18, wherein the first, second and third notches each have an asymmetrical shape.

23. The serrated fan blade according to claim 22, wherein the first, second and third notches each include a first side and a second side, the first side being closer to the outer distal end than the second side and being longer than the second side.

24. The serrated fan blade according to claim 16, wherein the first, second and third notches each include a round bottom portion.

25. The serrated fan blade according to claim 16, wherein the first and second serrations each include a round apex portion.

26. A serrated fan blade comprising:
an airfoil structure including:
a leading edge and a trailing edge, the leading edge and the trailing edge each extending between an inner base and an outer distal end; wherein
the trailing edge includes a plurality of notches including a first notch, a second notch, a third notch, and a fourth notch adjacent to each other in a row;
the first notch and the second notch define a first serration between the first notch and the second notch;
the second notch and the third notch define a second serration between the second notch and the third notch;
the third notch and the fourth notch define a third serration between the third notch and the fourth notch; and
the second and the third notches each have a depth that is smaller than depths of the first and fourth notches.

27. An axial fan comprising:
a motor; and
an impeller connected to the motor, the impeller including a hub and a plurality of fan blades connected to the hub; wherein
each of the plurality of fan blades is the serrated fan blade according to claim 16.

28. An axial fan comprising:
a motor; and
an impeller connected to the motor, the impeller including a hub and a plurality of fan blades connected to the hub; wherein
each of the plurality of fan blades is the serrated fan blade according to claim 23; and
portions of a lateral surface of the trailing edge of each serrated fan blade, which are portions positioned on the second side of the notches, are visible from an inlet side.

29. A centrifugal fan impeller having a central axis, the centrifugal fan impeller comprising:
an inlet ring;
a back plate; and
a plurality of fan blades located between the inlet ring and the back plate about the central axis; wherein
the plurality of fan blades each include a leading edge on an inner side in a radial direction, a trailing edge on an outer side in the radial direction, a first end portion connected to the inlet ring, and a second end portion connected to the back plate;
at least either one of the leading edge and the trailing edge includes a plurality of notches including a first notch, a second notch, and a third notch adjacent to each other in a row;
the first notch and the second notch define a first serration between the first notch and the second notch;
the second notch and the third notch define a second serration between the second notch and the third notch;
the second notch has a depth that is largest or smallest among depths of the first, second and third notches; and
the first and the second serrations each have an asymmetrical shape.

30. A centrifugal fan comprising:
a motor; and
an impeller connected to the motor; wherein
the impeller is the centrifugal fan impeller according to claim 29.
